(19) United States
(12) Patent Application Publication
(10) Pub. No.: US 2005/0067084 A1
(43) Pub. Date: Mar. 31, 2005

(54) Method and article for evaluating and optimizing joined thermoplastic parts

(76) Inventors: Val A. Kagan, Morristown, NJ (US); Christopher Roth, Madison, NJ (US)

Correspondence Address: Herbert B. Keil;KEIL & WEINKAUF, 1350 Connecticut Ave., N.W., Washington, DC, 20036, US

(21) Appl. No.: 10/933,237

(22) Filed: Sep. 3, 2004

Related U.S. Application Data
(60) Provisional application No. 60/499,374, filed on Sep. 3, 2003.

(51) Int. Cl. B29C 45/00; B29C 45/16; B32B 31/00

(52) U.S. Cl. 156/64; 264/40.1; 264/255; 264/297.2; 264/328.1; 428/57

(57) ABSTRACT

A thermoplastic article is produced by welding or injection molding. The mechanical performance of the article is optimized by a method employing a plurality of test samples also produced by welding or injection molding. For welding, each test sample comprises two thermoplastic workpieces welded at an interface having a preselected shape. The test samples are prepared using different welding conditions and tested. The results are used to select injection molding conditions for the first and second workpieces. For injection molding, each test sample is prepared with a knit line having a preselected shape. The test samples are injection molded using different conditions and tested. The results are used to select welding conditions for the first and second workpieces. The test samples are much easier to prepare than samples that have to be machined from full-scale articles made under the requisite variety of experimental conditions heretofore required for process optimization. As a result, the performance of full-scale articles is more easily and expeditiously optimized.

### BACKGROUND OF THE INVENTION

1. Field Of The Invention

This invention relates to the joining of thermoplastic workpieces; and more particularly, to a method and article for evaluating and optimizing the joint configuration and the production process of welded or injection molded thermoplastic workpieces.

2. Description Of The Prior Art

Modern thermoplastic, polymeric materials are employed in a wide variety of industrial applications. In many cases, articles composed of suitable thermoplastic materials have been found to be advantageous replacements for metal or thermoset articles previously required. Mechanical requirements for a given application can often be met with a thermoplastic article that is cheaper, lighter, and more robust and durable than a comparable metallic or thermoset article. As a result, thermoplastics are now widely used in a diversity of applications in the marketplace.

Many applications of engineered plastics involve articles that have complex shapes. The service requirements for the articles normally impose performance criteria that may include thermal, mechanical, and chemical behavior. In many cases, the technical requirements and configuration for a given application are most effectively satisfied with an article formed by welding two or more separately formed workpieces or by injection molding. Sometimes different sections of the article are best made of different thermoplastic materials. Although the relevant properties of the individual workpieces normally are well understood and may be characterized using conventional testing methods, full-scale articles with joints, formed either by welding or one or more knit lines resulting from injection molding processes, often present a more serious challenge.

For welded joints, particular details, including factors such as the configuration of the mating surfaces and the welding conditions, are often crucial in determining whether or not a joined article meets its functional requirements. For example, the mating surfaces of workpieces being joined are sometimes shaped to give more surface area and mechanical strength than afforded by a simple, planar butt joint. In addition, the mechanical properties of the joint strongly depend on welding parameters such as welding temperature, holding pressures, and heating and cooling conditions.

In other situations, injection molding is advantageously employed to form complicated shapes. Generally stated, injection molding comprises the delivery of a fluidized material into a mold under pressure. The pressure allows the material to fill the mold quickly, before solidifying as heat is absorbed by the mold. Highly decorated or intricate shapes that would be impossible to cast under merely gravity-driven flow can be successfully molded in many instances by injection techniques. Material injected into the mold often flows in plural paths that eventually join together, forming an interface normally termed a knit line. Frequently, injection molding processes are enhanced by using of molds with multiple sprues that result in these plural paths. In addition, gated injection molding techniques have been developed to provide additional control over the molding process. Generally stated, one or more gates are inserted into the mold to block the flow of material during a portion of the injection cycle and subsequently removed to allow the remaining volume of the mold to be filled. Gated injection is often performed using an injection molding machine with multiple, independently operable barrels that may be configured to deliver different materials or be triggered at different points during the overall injection cycle.

Moreover, it is often found that the inter-phase volume in either welded or injection molded articles exhibits less favorable mechanical properties than the rest of the bulk material. In some cases, the inter-phase region completely dominates the mechanical properties of the respective finished items, requiring a designer to adjust the configuration of the article accordingly. The term “inter-phase” is used herein and in the subjoined claims to refer generally to a volume surrounding the joint of welded workpieces or the knit line in molded articles. More specifically in the case of welded joints, the term is to be understood as the volume in the vicinity of the actual interface, which softens or melts during the welding operation. For injection-molded parts, the term refers the volume in the vicinity of a knit line wherein the structure or properties are substantially affected by the impingement of different flows within the mold. The material within the “inter-phase” volume in either welded or injected articles may be distinguished by one or more altered chemical, mechanical, or microstructural characteristics, which differ from the comparable characteristics in the bulk of the material. The differences include one or more of chemical composition; orientation, density, and uniformity in distribution of fiber reinforcements if present; the density of mineral or other fillers; the degree of crystallinity; and other skin-core effects. Depending on specific processing conditions, the inter-phase typically extends well beyond the actual interface, which is understood only to encompass the immediate volume in which polymer chains extend from one volume to the other. The inter-phase often extends 30 to 500 μm from the interface in a welded joint, and 300 to 1200 μm away for knit lines. Therefore, careful attention must be paid to optimizing the welding or molding process to minimize this disruption of microstructure, so that the inter-phase retains as much strength as possible without unduly compromising joint integrity.

The aforesaid microscopically altered characteristics can arise in a number of ways. In some cases, the thermal history in the inter-phase region changes the molecular chemistry or the crystallinity distribution therein. Even the mere admixture of the materials in the affected volume is sometimes problematic. In other cases wherein different materials are joined, there are substantially different heat softening or melting temperatures. Heating one of these different parts above the higher of the temperatures may be deleterious to the other part, causing it to become so soft that it loses its general shape or properties. In extreme cases, some of the materials would decompose or otherwise chemically react at the temperatures needed to soften the other constituents.

Achieving a satisfactory joint is especially challenging if the article is comprised of workpieces made of chemically incompatible thermoplastics. Representative lists of materials and their relative chemical compatibilities are found at pages 462 and 464 of Joining of Plastics: Handbook for Designers and Engineers, edited by Jordan Rotheiser (Cincinnati: Hanser Publishers), which pages are incorporated herein by reference thereto. Admixing chemically incompatible thermoplastics in the inter-phase volume frequently produces material that is locally weaker than either material by itself.

Fiber-reinforced materials present an even more severe challenge, as the benefit imparted by the reinforcement depends on maintaining a suitable orientation of the fiber axes in the thermoplastic matrix. The axial orientation of fibers generally follows a flow direction. In both welding and injection molding, there are complicated flow patterns in the inter-phase region. As a result, the local orientation distribution of the fibers depends strongly on process details. The expected reinforcement imparted by the fibers is often greatly diminished or eliminated, so the expected effective strength of the part in a given direction often lost. In some cases, the strength is even reduced to that of the base resin, and in certain instances even lower.

The difficulty of suitably processing fiber-reinforced materials is apparent in FIGS. 1A-1B, which show respectively the microstructure in the inter-phase region of welded and injection molded articles of manufacture composed of nylon 6 with 33 wt. % glass reinforcing fiber. In FIG. 1A, article 100 is formed of workpieces 102, 104 joined in inter-phase region 106 by vibratory welding. Article 120 in FIG. 1B is injection molded, with flows 122, 124 impinging to form inter-phase 126. The differences between the inter-phase microstructures 106 and 126 and the corresponding bulk microstructures outside the inter-phase are readily perceived. In the welded joint of FIG. 1A, only a few fibers traverse the interface in region 106, leading to locally reduced strength. Likewise, injection molded article 120 includes regions in the inter-phase region 126 with a substantially reduced density of fibers, e.g. region 128, which also exhibit reduced strength.

It is generally expensive, complex, and time-consuming to carry out prototyping and process design optimization to overcome these problems using full-scale workpieces. Even using minimized, designed experiment methodologies such as the Taguchi method, the number of molds or other near net-shape fabrications needed for the desired trials is often prohibitive. Techniques that permit simulation of final designs using optimization of simpler model systems therefore would be extremely attractive to workers in the plastics industry.

### SUMMARY OF THE INVENTION

The present invention provides an economical, efficient method for optimizing the mechanical performance of articles formed by welding or injection molding thermoplastic workpieces, the optimization comprising the use of standard test samples. In one aspect, the method is used to optimize the mechanical performance of a thermoplastic article comprising a first workpiece and a second workpiece welded together at an interface. Generally stated, the method comprises the steps of: (i) preparing and testing a plurality of test samples to produce test results; and (ii) selecting welding conditions for welding the workpieces to form the thermoplastic article. The production of each test sample comprises either welding or injection molding. In the several welding embodiments, the test sample comprises a first test workpiece and a second test workpiece that are welded together at a test sample interface having a test sample interface shape. Preferably, the test sample is fabricated by a process comprising injection molding, in which the first and second test workpieces are regions joined at a knit line during the molding process, which may involve multiple steps and incorporate gating. The first workpiece and the first test workpiece are composed of a first thermoplastic material; the second workpiece and the second test workpiece are composed of a second thermoplastic material. The first and second thermoplastic materials may be different materials but preferably are substantially the same thermoplastic material. The test results are used to select welding conditions comprising at least one of weld temperature, weld amplitude, weld clamping pressure, weld cooling pressure, heating and cooling rates, and shape of the interface of the article. Other factors important to the properties of the weld may also be included and optimized.

In another aspect, the invention provides a method for optimizing the mechanical performance of an injection molded thermoplastic article comprising a first portion and a second portion joined at a knit line. Generally stated, the method comprises the steps of: (i) preparing and testing a plurality of test samples to produce test results; and (ii) selecting conditions for injection molding the article. Each test sample is prepared by an injection molding process and comprises a first test portion and a second test portion that join at a test sample interface. The test results are used to select injection molding conditions for producing the article and comprise at least one of temperature, weld clamping pressure, weld cooling pressure, weld amplitude, and shape of the knit line of the article. Other factors important to the properties of the weld may also be included and optimized.

The method of the invention is suited for optimizing articles composed of a wide variety of polymeric materials, including ABS (acrylonitrite/butadiene/styrene), ASA (acrylonitrite/styrene/acrylate), BS (styrene/butadiene block copolymer), MABS (methyl methacrylate/acrylonitrite/butadiene/styrene), Nylons 6, 66, 46, and 12 (polyamide), PSU (polysulfone), PE (polyethylene), PEX (cross-linked polyethylene), PP (polypropene), PES (polyethersulfone), POM (polyoxymethylene), PEK (polyether ketone), PEEK (polyether ether ketone), PS (polystyrene), PVC (polyvinyl chloride), PPS (polypropylene sulfide), and SAN (styrene/acrylonitrite copolymer). In some embodiments, the method of the invention advantageously allows optimization of the mechanical properties of articles comprising plural materials having some degree of chemical incompatibility.

The optimization methods provided by the present invention allow conditions used in welding and injection molding processes to be selected much more economically and efficiently as the result of using test samples that generally function as surrogates for test samples that would otherwise have to be machined from finished articles. The test samples incorporate joints or knit lines that result in mechanical properties that are similar to those that would be exhibited by samples taken from the finished articles that incorporate similarly joined regions wherein the interfaces are similarly shaped. Optimization of conditions such as heat, pressure, exposure to heating radiation, and other salient parameters characterizing welding and injection molding processes can be replicated in the formation of the test samples. As a result, the expense, inconvenience, and difficulty of carrying out trials that entail forming large-scale parts, which subsequently must be destructively tested, is virtually eliminated. In addition, many finished articles have a three-dimensional geometry such that their joints occur at positions that do not allow test samples with standard geometry to be fabricated. For example, cylindrical articles having joints interrupting the circumference are not conveniently tested, since there is no planar region that can be sectioned to provide standard planar test samples. By way of contrast, the processes used to construct such items may be readily optimized in accordance with the present method. Moreover, the ease of fabricating test samples in accordance with the present method allows a more thorough optimization, since more replicate testing and a wider range of experimental conditions may be explored at a feasible cost, compared to prior full-scale testing methods.

In the case of injection molding, finite element modeling techniques, including those implemented using computer software sold under tradenames such as Moldflow and SigmaSoft, are often used to simulate the flow patterns in the mold during injection. However, they do not provide adequate information, particularly for fiber-filled melts, to allow mechanical properties in the inter-phase region to be inferred. Consequently, in use of such finite element modeling techniques, additional, confirmatory mechanical testing of samples taken from the full-scale articles has heretofore been required. The present method permits that testing to be minimized.

### BRIEF DESCRIPTION OF THE DRAWINGS

The invention will be more fully understood and further advantages will become apparent when reference is had to the following detailed description of the various embodiments of the invention and the accompanying drawings, wherein like reference numerals denote similar elements throughout the several views, and in which:

FIG. 1A is a photomicrograph depicting the microstructure of a joint between nylon 6 workpieces with 33 wt. % glass fiber reinforcement vibration welded using a prior-art process;

FIG. 1B is a photomicrograph depicting the microstructure of a knit line in a nylon 6 workpiece with 33 wt. % glass fiber reinforcement injection molded using a prior-art process;

FIG. 2 is a schematic plan view depicting an injection-molded test sample made in accordance with the present invention;

FIGS. 3A-3G are schematic, cross-sectional views of inter-phase regions with various configurations near welds joining thermoplastic workpieces in accordance with the present invention;

FIGS. 4A-4C are schematic, cross-sectional views depicting stages of a method for forming a thermoplastic test sample by a gated injection molding process in accordance with the present invention; and

FIG. 5 is a schematic, cross-section view depicting a process for welding two thermoplastic workpieces in accordance with the present invention.

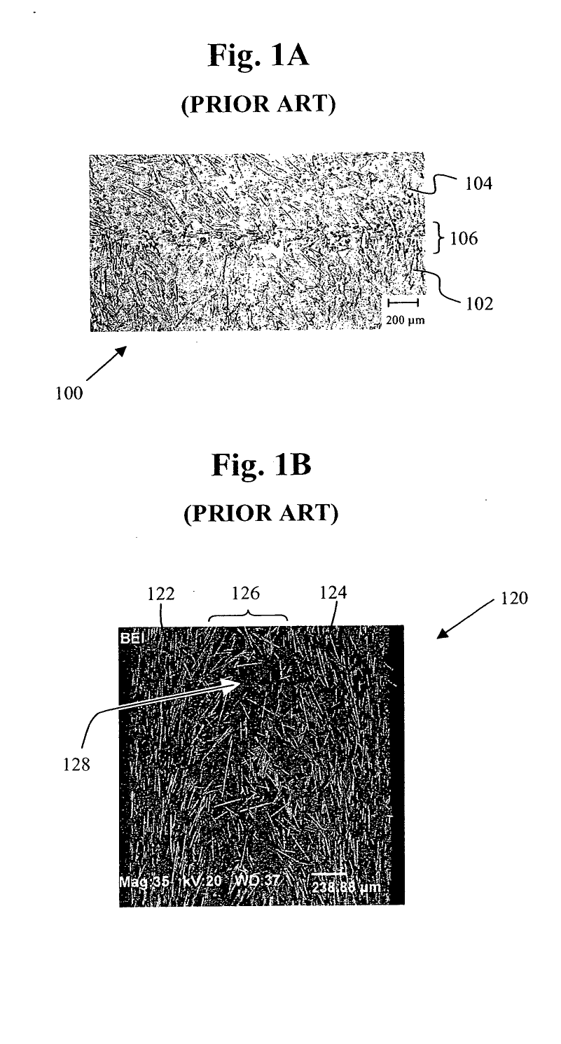

### DETAILED DESCRIPTION OF THE PREFERRED EMBODIMENTS

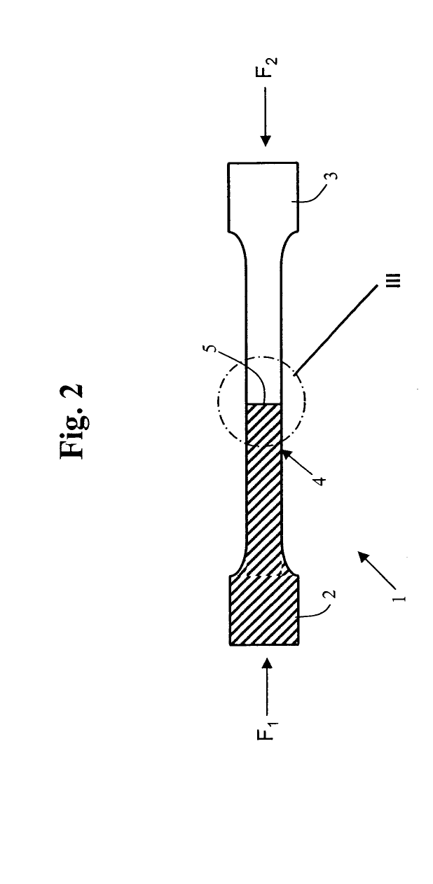

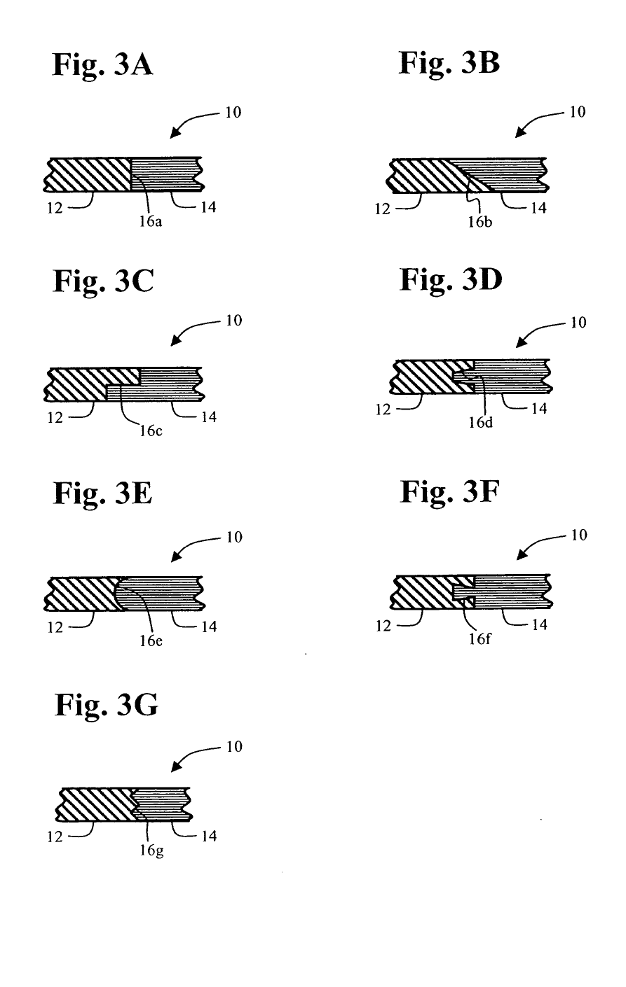

In one aspect, the present invention is directed to the optimization of mechanical properties of thermoplastic articles made by welding or injection molding. The optimization method of the present invention is preferably carried out using mechanical testing data obtained with test samples such as that depicted generally at 1 in FIG. 2. The geometry of the test samples, including their dimensions and shape, is normally chosen in accordance with recognized protocols established by entities such as the American Society for Testing of Materials (ASTM) and the International Standards Organization (ISO). Sample 1 includes end grip portions 2, 3 and an active gage portion 4 with an interface 5 and an inter-phase region substantially in the center of gage portion 4. Various shapes that interface 5 can assume are shown in the enlarged views of region III seen in FIGS. 3A-3G. The present test samples are generally planar, but may also be cylindrical for some applications.

Test sample 1 may be produced by any suitable welding or injection molding technique. Preferably test sample 1 is formed directly in near net shape form, but may also be machined from a larger test specimen. For welding, sample 1 comprises test workpieces, which are first produced by any suitable molding or machining process that provides the selected, complementary interface surfaces and then are welded. The welding may be carried out by any desired vibratory, thermal, or solvent-based process known in the plastics art. Alternatively but preferably, test sample 1 may be produced by a suitable injection molding process wherein a central knit line is formed by the impingement of flows oppositely directed along the sample length, as indicated by F₁ and F₂. Both injected molded and welded samples may be formed of either a single material on both sides of the interface or different materials that may or may not be chemically compatible.

The present test samples are fabricated with an interface having any of a wide variety of shapes that replicate the joints and knit lines employed in finished items. Representative shapes include those depicted in FIGS. 3A-3G. Generally stated, the molded or welded item 10 comprises portions 12, 14 on either side of the interface. Various configurations of the interface may be employed, including the butt shape 16a of FIG. 3A. In other embodiments, the shape of the interface is preferably one of the scarf 16b of FIG. 3B, the overlap or rabbet 16c of FIG. 3C, the tongue and groove 16d of FIG. 3D, the round shape 16e of FIG. 3E, the dovetail 16f of FIG. 3F, and the tooth 16g of FIG. 3G. Compared to the simple butt 16a, each of the other joints shown in FIGS. 3B-3G provides more surface area and mechanical interlocking that promote higher axial and shear strength. In addition, the test samples are preferably formed with the same materials as the full-scale article being optimized and with an interface having substantially the same shape as that used in the full-scale article. As a result, the present test sample has substantially the same mechanical properties as would a hypothetical test sample having a similar inter-phase geometry and configuration and made with the same materials and machined or otherwise sectioned from the full-scale article and similarly configured

Gated injection molding processes are useful in forming many articles in accordance with the present invention. For example, the formation of knit lines often can be more precisely localized by suitable gating. Suitable contouring of the gates also allows the shape of the interface to be controlled to some extent. In one implementation of a gating technique, one side of an interface is first defined by a gate and formed by injection. Then the gate is withdrawn and additional material is injected and flows to meet the earlier-injected material and bond with it to complete the formation of the ultimate article.

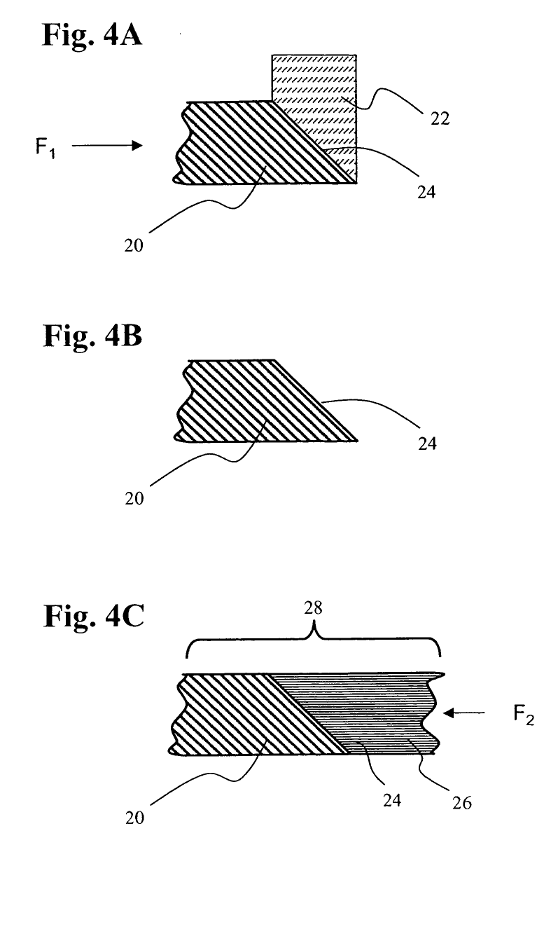

Referring now to FIGS. 4A-4C, there is depicted schematically a gated injection molding process by which a test specimen 28 having a scarf-type interface is formed. In the first step (seen in FIG. 4A), a gate or mold insert 22 is inserted through an aperture into a mold (not shown). The gate 22 has an angled face contoured to produce a scarf face 24 at a requisite angle. A flow of thermoplastic material is injected from one end of the mold in the direction designated by F₁. The gate is retracted, leaving a first portion 20 with an angulated face 24 as seen in FIG. 4B. Then a second flow is injected in a direction F₂ to form a knit line at face 24 and complete specimen 28 composed of first portion 20 and second portion 26 (FIG. 4C). In some embodiments, the portions 20, 26 are composed of the same thermoplastic material, while in other embodiments, different thermoplastic materials are used.

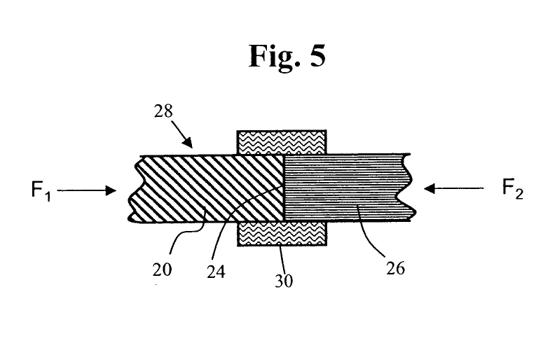

In another embodiment of the present invention, depicted by FIG. 5, test specimen 28 having a butt interface is produced by injection molding. The properties of the inter-phase region of specimen 28 are adjusted by temperature control during the injection molding process. For example, the region may be heated by heater 30 or cooled by a chiller such as a water jacket (not shown).

Test samples produced in accordance with the invention are tested using known mechanical testing methods, such as those delineated by ASTM Standard 638, which is incorporated herein by reference thereto. The use of a standardized mechanical testing protocol, including a standard test sample geometry, imparts a much greater reproducibility to the data. Preferably, a suitable test matrix entailing a plurality of conditions is selected, by which the effects of the particular welding or injection molding techniques and/or joint geometry can be elucidated. More preferably, the test matrix is chosen to provide a particular set of factorial experiment design conditions, which may be a partial or full factorial design. The test matrix may include a suitable number of replicates to obtain adequate precision. Usually each factor is tested at two levels, but other designs, some with more than two levels, may also be used. The experimental design is constructed using known statistical techniques such as the Taguchi method. Corresponding test samples are produced and tested. The results of the testing are then analyzed using known statistical analysis methods to determine an optimal selection of the processing conditions studied. The conditions, thus selected, are then applied to the formation of the full-scale article by welding or injection molding.

In most instances, process optimization can be carried out far more expeditiously and at much lower cost using the test sample method delineated herein than with previous methods that depended on making and testing full scale articles of manufacture. Articles of manufacture made with welding or injection molding processes optimized in accordance with the present method beneficially exhibit improved mechanical properties.

Test samples of the form depicted in FIG. 2 may be machined from simple test specimens, such as planar rectangular coupons. Preferably, test samples are formed directly, instead of having to machine them from a larger part. The use of a directly-produced test samples is especially beneficial in instances wherein the required final part does not have any portion from which a planar or cylindrical test sample with a centrally located inter-phase region can be machined. For example, the part may be curvilinear and lack any planar region where the inter-phase of interest is located. However, applying a uniaxial force (as is normally done in mechanical testing) to a test sample that is not planar or cylindrically symmetrical results in a complex, generally unpredictable stress pattern. The resultant data are thus compromised and of limited value, rendering interpretation very difficult. These difficulties are substantially eliminated by using samples having standardized geometries, as described hereinabove in greater detail.

In the case of thermal welding, the parameters and conditions typically optimized include heat input and the resulting peak temperature, pressure during heating and cooling, and heating and cooling rates. For vibratory welding methods, the amplitude and direction of vibration are also included, while the parameters for optical and electromagnetic radiation methods include the intensity, frequency, duration, and pattern of radiation. For injection molding, flow rates, design of mold including flow patterns and sprues, injection and hold pressure, and melt and mold temperature are among the salient parameters.

The present optimization method is advantageously used in connection with a number of welding processes. In some instances, especially those wherein the workpieces are relatively compatible chemically, simple hot-plate and other non-contact, radiant heating techniques may be used. Hot-plate methods are readily implemented for joints in which the mating surfaces are planar. Other geometrically simple mating surfaces, such as the scarf surfaces illustrated in FIG. 3B and the round surfaces of FIG. 3E may be heated on conformally designed heated surfaces. Typically, one or both of the workpieces are heated to melt the mating surface. The workpieces are then quickly brought into abutment and joined. However, reliable welding by this method necessitates tight process control and very careful mechanical handling to assure proper mating. Moreover, hot-plate methods are generally applicable only in joining workpieces with similar, chemically compatible compositions.

Solvent welding is useful in some instances. In this technique, a suitable solvent for the thermoplastic is first applied to one or both of the mating joint surfaces to soften them. The workpieces are then brought into contact, and the joint is allowed to harden. Significant environmental concerns attend many of the commonly used solvents. In addition, it is difficult to eliminate all of the residual solvent, so the technique is generally considered unsuitable for manufacture of parts intended for use in medical applications.

Preferably, welding is accomplished by energy imparted by friction or impingement of radiation at the joint area. Frictional welding methods widely used with thermoplastic parts may broadly be classified as vibrational (linear and orbital), rotational/spin, or ultrasonic. In both vibrational and rotational methods the workpieces are brought into mating contact and moved relative to each other in a direction substantially in the plane of the joint surface while being urged together under compressive force. The resulting friction rapidly heats the joint area to cause melting and welding. With vibrational methods the workpieces are moved relative to each other in an oscillatory linear or orbital pattern. The rotational method (spin welding) entails rapidly spinning one of the workpieces and bringing it into contact with its mate. However, spin welding is suitable only for relatively short parts having joint surfaces that are cylindrically symmetrical, and becomes increasingly impractical as part size increases. In addition, spin welding requires very precise alignment of the parts to get a uniform weld fully encircling the final article, which is essential if high strength or hermetic sealing is required.

Ultrasonic welding is also widely applied for joining thermoplastics, especially for mass production of relatively small articles in which high throughput and speed of welding are advantageous. Amorphous thermoplastics are regarded as most amenable to ultrasonic welding, especially if a hermetic joint is needed. The process is also widely used for semicrystalline, filled, and fiber-reinforced thermoplastics. However, the apparatus for ultrasonic welding and the required disposition of the parts therein generally precludes its use for large parts.

In other cases, heating may be carried out by impingement of radiation, either by radio frequency electromagnetic induction or by optical or laser techniques. Such techniques are usually employed after the workpieces are disposed in position for welding. In the electromagnetic induction technique, a radio frequency absorbing material is either placed on one or more of the surfaces being joined or incorporated in the bulk at least part of the material being joined. The joint area is exposed to an electromagnetic field of a frequency at which the absorbing material is effective. Energy absorbed from the field generates local heating that causes localized melting and welding of the subject parts. Any conducting or semiconducting material having suitable absorption may be used, including metal powders such as iron. Suitable systems equipment and absorbing materials are available commercially under the tradenames EMABOND and EMAWELD from the Ashland Specialty Chemical/Emabond Company, Norwood, N.J.

Laser techniques are also advantageously used in forming the present structures. Preferably, the material used in one of the workpieces is transparent to light of a preselected wavelength, while the other workpiece absorbs light of the same wavelength. Alternatively, at least a portion of the mating area of one workpiece is coated with an optically absorbing substance, such as carbon black. As used herein, the term “light” is understood to mean any electromagnetic radiation having a wavelength ranging from infrared to ultraviolet; “light” is not limited to radiation of wavelengths perceptible to human vision. Preferably, infrared light furnished by either an infrared, filament-type lamp or a laser is used for best effectiveness of welding. It is further preferred that the light be furnished by a laser selected from the group consisting of Nd:YAG, diode, CO₂, or excimer lasers. In a more preferred implementation, laser light absorbing dyes such as those disclosed in published International Patent Application WO 00/20157 are incorporated in one or both workpieces.

In a preferred embodiment, the present optimization is used to optimize the mechanical properties of a welded article using test samples formed by injection molding. By suitably adjusting the temperature profile and related conditions during the injection molding process, the test samples are unexpectedly found to function as accurate surrogates for test samples composed of workpieces that machined and welded. In many instances, the injection process needed for small parts like the test samples can be implemented quickly and economically. As a result, a large number of samples can be made, permitting a wide range of joining conditions to be explored with sufficient replicate experiments to assure the needed precision. In many situations, additional factors influencing joining can be added to an experimental design that would be infeasible within practical constraints if full-scale articles had to be made, from which corresponding test samples would have to be cut.

Having thus described the invention in rather full detail, it will be understood that such detail need not be strictly adhered to but that various changes and modifications may suggest themselves to one skilled in the art, all falling within the scope of the present invention as defined by the subjoined claims.

1. A method for optimizing the mechanical performance of a thermoplastic article comprising a first workpiece and a second workpiece welded together at an interface having a shape, the method comprising the steps of:
a) preparing a plurality of test samples, each comprising a first test workpiece and a second test workpiece that are joined together at a test sample interface having a test sample interface shape, said first workpiece and said first test workpiece being composed of a first thermoplastic material and said second workpiece and said second test workpiece being composed of a second thermoplastic material;
b) testing said plurality of test samples to produce test results; and
c) selecting welding conditions for welding said first and second workpieces based on said test results, said selecting comprising choice of at least one of weld temperature, weld amplitude, weld clamping pressure, weld cooling pressure, heating and cooling rates, and shape of said interface of said article.

2. The method of claim 1, wherein said first and second test workpieces are joined by welding.

3. The method of claim 2, wherein said plurality of said test samples are prepared under different welding conditions, and said selecting comprises statistical analysis of said test results.

4. The method of claim 3, wherein said welding conditions comprise a factorial experiment design.

5. The method of claim 1, said test workpieces being prepared by an injection molding process and joined at a knit line forming said test sample interface having said test sample interface shape.

6. The method of claim 5, wherein said plurality of said test samples are prepared under different injection molding conditions, and said selecting comprises statistical analysis of said test results.

7. The method of claim 6, wherein said injection molding conditions comprise a factorial experiment design.

8. The method of claim 1, wherein said test sample interface has a butt shape.

9. The method of claim 1, wherein said test sample interface has a shape selected from the group consisting of scarf, overlap, tongue-and-groove, round, dovetail, and tooth.

10. The method of claim 1, wherein said first and second workpieces are composed of substantially the same thermoplastic material.

11. The method of claim 1, further comprising the step of welding said first and second workpieces to form said article.

12. The method of claim 7, wherein said interface and said test sample interface have substantially the same shape.

13. A thermoplastic article of manufacture comprising a first workpiece and a second workpiece joined together at an interface having a shape by a welding process, characterized in that said welding process is optimized by a method comprising the steps of:
a) preparing a plurality of test samples, each comprising a first test workpiece and a second test workpiece joined together at a test sample interface having a test sample interface shape, said first workpiece and said first test workpiece being composed of a first thermoplastic material and said second workpiece and said second test workpiece being composed of a second thermoplastic material;
b) testing said plurality of test samples to produce test results; and
c) selecting welding conditions for said welding process based on said test results, said selecting comprising choice of at least one of weld temperature, weld amplitude, weld clamping pressure, weld cooling pressure, heating and cooling rates, and shape of said interface of said article.

14. A test sample for characterizing the mechanical properties of a thermoplastic article comprising a first workpiece and a second workpiece joined together, said test sample comprising a first test workpiece and a second test workpiece welded together at a test sample interface having a test sample interface shape and exhibiting substantially the same mechanical properties as would a test sample machined from said thermoplastic article and comprising a first portion and a second portion welded together at an interface having a shape that is substantially the same as said preselected shape, said first portion and said first test workpiece being composed of substantially the same material, and said second portion and said second test workpiece being composed of substantially the same material.

15. A test sample for characterizing the mechanical properties of a thermoplastic article comprising a first workpiece and a second workpiece joined together, said test sample comprising a first test workpiece and a second test workpiece prepared by an injection molding process and joined at a knit line forming a test sample interface having a test sample interface shape, said test sample exhibiting substantially the same mechanical properties as would a test sample machined from said thermoplastic article and comprising a first portion and a second portion welded together at an interface having a shape that is substantially the same as said preselected shape, said first portion and said first test workpiece being composed of substantially the same material, and said second portion and said second test workpiece being composed of substantially the same material.

16. A method for optimizing the mechanical performance of an injection molded thermoplastic article comprising a first portion and a second portion joined at a knit line having a shape, the method comprising the steps of:
a) preparing a plurality of test samples, each comprising a first test portion and a second test portion and being prepared by an injection molding process, said first and second test portions being joined at a test sample knit line having a test sample knit line shape;
b) testing said plurality of test samples to produce test results; and
c) selecting conditions for injection molding said article based on said test results, said selecting comprising choice of at least one of melt temperature, mold temperature, injection pressure, hold pressure, cooling time, holding time, and shape of said knit line of said article.

17. The method of claim 16, wherein said preparing of said test sample comprises a multiple-gated injection molding process.

18. The method of claim 16, wherein said plurality of test samples are prepared under different injection molding conditions, and said selecting comprises statistical analysis of said test results.

19. The method of claim 16, wherein said injection molding conditions comprise a factorial experiment design.

20. The method of claim 16, wherein said test sample knit line has a butt shape.

21. The method of claim 16, wherein said test sample knit line has a shape selected from the group consisting of scarf, overlap, tongue-and-groove, round, dovetail, and tooth.

22. The method of claim 16, wherein said first and second portions are composed of different thermoplastic materials.

23. The method of claim 16, wherein said first and second portions are composed of substantially the same thermoplastic material.

24. The method of claim 16, further comprising the step of injection molding said article using said selected injection molding conditions.

25. The method of claim 24, wherein said knit line of said article and said test sample knit line have substantially the same shape.

26. An injection molded thermoplastic article of manufacture comprising a first portion and a second portion joined at a knit line having a shape during an injection molding process, characterized in that said injection molding process is optimized by a method comprising the steps of:
a) preparing a plurality of test samples, each comprising a first test portion and a second test portion and being prepared by an injection molding process, said first and second test portions being joined at a knit line;
b) testing said plurality of test samples to produce test results; and
c) selecting conditions for said injection molding process based on said test results, said selecting comprising choice of at least one of melt temperature, mold temperature, injection pressure, hold pressure, cooling time, holding time, and shape of said knit line of said article.
